(19) United States
(12) Patent Application Publication
(10) Pub. No.: US 2024/0246883 A1
(43) Pub. Date: Jul. 25, 2024

(54) HEATED PEAT AS A SLOW RELEASE ORGANIC FERTILIZER

(71) Applicant: University of Florida Research Foundation, Inc., Gainesville, FL (US)

(72) Inventor: Mica F. MCMILLAN, Gainesville, FL (US)

(21) Appl. No.: 18/422,115

(22) Filed: Jan. 25, 2024

Related U.S. Application Data
(60) Provisional application No. 63/440,999, filed on Jan. 25, 2023.

(51) Int. Cl. C05G 3/40; C05F 11/04

(52) U.S. Cl. CPC C05G 3/40; C05F 11/04

(57) ABSTRACT

In one aspect, the disclosure relates to slow-release fertilizers including a peat and an optional filler material such as, for example sand, methods of making the same, methods of improving the growth of plants including using the same, and plants grown using the disclosed methods. The slow-release fertilizers are environmentally safe and conducive to the establishment of various plants, including ground cover plants. In some aspects, the slow-release fertilizers induce soil-water repellency in systems in which they are applied and can be useful for research as well as horticultural purposes. In another aspect, the slow-release fertilizers provide increased levels of ammonia, amino acids, and other nutrients relative to conventional fertilizers. This abstract is intended as a scanning tool for purposes of searching in the particular art and is not intended to be limiting of the present disclosure.

### CROSS REFERENCE TO RELATED APPLICATIONS

This application claims the benefit of U.S. Provisional Application No. 63/440,999 filed on Jan. 25, 2023, which is incorporated herein by reference in its entirety.

### BACKGROUND

Peat is the partially decayed organic layer composed of plant material that is typically found in wet areas like bogs, peatlands, mires, and the like. Heating or burning peat for fuel or as an energy source was and, in some countries, still is a common practice. Peatlands are found all over the world with a wide variety of compositions; common varieties include Canadian sphagnum peat moss, Florida and North Dakota reed sedge peat, and Montana hypnum peat. Untreated peat has been used for decades as the main component for soilless substrates in the horticulture industry. It is valued for its low pH (3.0-5.0), high cation exchange capacity (CEC), high water and nutrient holding capacity, light weight, and stability.

Plant uptake of inorganic nitrogen (N) sources such as ammonium and nitrate dominates current understanding of plant nitrogen utilization. However, in the last twenty years, more emphasis has been placed on organic N sources found in the soil. Uptake studies of organic N sources such as amino acids has revealed that plants can absorb amino acids directly from the soil as quickly as they absorb inorganic N sources. It has thus been suggested that organic N sources, such as amino acids and proteins, may enhance root growth.

Despite advances in fertilizer research, there is still a scarcity of organic nitrogen sources that are, inexpensive, widely available, and sustainable, while also being effective and homogeneous in performance and that enhance root and shoot growth. These needs and other needs are satisfied by the present disclosure.

### SUMMARY

In accordance with the purpose(s) of the present disclosure, as embodied and broadly described herein, the disclosure, in one aspect, relates to slow-release fertilizers including a peat and an optional filler material such as, for example sand, methods of making the same, methods of improving the growth of plants including using the same, and plants grown using the disclosed methods. The slow-release fertilizers are environmentally safe and conducive to the establishment of various plants, including ground cover plants. In some aspects, the slow-release fertilizers induce soil-water repellency in systems in which they are applied and can be useful for research as well as horticultural purposes. In another aspect, the slow-release fertilizers provide increased levels of ammonia, amino acids, and other nutrients relative to conventional fertilizers.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a photograph showing water remaining on the surface of and not infiltrating into hydrophobic soap coated sand (HSS) substrate.

FIG. 2 is a photograph showing water remaining on the surface of and not infiltrating into hydrophobic sand and reed sedge peat mixture (HSP) substrate.

FIG. 3 is a photograph showing a preferential water flow path exhibited in HSS substrate.

FIG. 4 shows total amino acids (w/w %) in heated peat versus unheated peat for reed sedge peat.

FIG. 5 shows roots on the right are from otherwise identical seeds grown with and without heated peat. Right: roots that were grown in the disclosed heated peat mixture before transplant into compost. Left: roots from seeds that were grown in industry standard media then transplanted into compost. Note the greater length, volume, and density of the roots grown in the heated peat compared to the unheated peat.

FIG. 6A shows from left to right, plants grown in heated peat alone, unheated peat alone, heated peat+PRO-MIX® (Premier Tech Home and Garden, Quakertown, PA, USA) (50:50), unheated peat+PRO-MIX® (50:50), PRO-MIX® alone. Arugula seeds were planted in the above treatments then transplanted in compost. Not only was root size greater, but top growth was also increased in heated peat treated growth media. FIG. 6B shows a close-up view of the leftmost plant in FIG. 6A, displaying increased volume of the root at the shoot/rhizome interface.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Climate change and extreme weather events as well as associated population shifts require reassessment of which lands can be considered arable; such reassessment includes developing a better understanding of natural resources that are available to growers and could be utilized for centuries due to their sustainability and their conduciveness to supporting ground cover, crops, and the like.

In one aspect, it has been discovered herein that subjecting reed sedge peat to heat for two hours induces a severely hydrophobic peat. In another aspect, however, the act of heating reed sedge peat also releases significant amounts of nitrate, ammonium, and amino acids. This release is not visually evident for a prolonged period of time; thus, the heated peat behaves similarly to a slow-release fertilizer. In a further aspect, plant response to a heated peat treatment was significantly better quality, color, and enhanced root and shoot growth. In another aspect, an increased amount of amino acids in the growth medium for a plant can enable the plant to better withstand abiotic stresses (e.g., drought, salinity, extreme temperatures, and the like) and disease.

Thus, in one aspect, disclosed herein is a method for creating a slow-release fertilizer having a high level of soil-water repellency and/or hydrophobicity, the method including at least the steps of heating a composition including peat to an elevated temperature and allowing the composition to cool to ambient temperature, thereby creating the fertilizer. In some aspects, the composition further includes a filler material, while in other aspects, the method includes blending a filler material and peat or the composition including heat prior to heating the composition. In some aspects, the filler material can include sand, perlite, vermiculite, limestone, or any combination thereof. In one aspect, when the filler is sand, the sand can have an average particle diameter of about 0.5 mm. In another aspect, the composition, with or without the filler material, can be used as a soil amendment by, for example, placing the composition on top of the soil in which plants are grown. In other aspects, the peat can be reed sedge peat, sphagnum peat, Latvian peat, Florida peat, another peat, or a mixture of different peat types. In still another aspect, the filler and peat can be heated in an oven or by any other suitable means to a temperature of from about 175° C. to about 200° C., or of at least about 180 ºC, or of about 175, 180, 185, 190, 195, or about 200° C., or a combination of any of the foregoing values, or a range encompassing any of the fore going values. In any of these aspects, the fertilizer can include about 90% (v/v) of the filler and about 10% (v/v) of the peat, or can include about 80% (v/v) of the filler and about 20% (v/v) of the peat, or a combination of any of the foregoing values, or a range encompassing any of the foregoing values. In some aspects, the fertilizer includes from about 0.5% to about 100% of the peat, or about 0.5, 1, 5, 10, 15, 20, 25, 30, 35, 40, 45, 50, 55, 60, 65, 70, 75, 80, 85, 90, 95, or about 100%, or a combination of any of the foregoing values, or a range encompassing any of the foregoing values.

Also disclosed herein are natural and organic slow-release fertilizers produced by the disclosed methods. In one aspect, the hydrophobic slow-release fertilizers have a water drop penetration time (WDPT) of about 5 seconds or longer, where a procedure for determining WDPT for a given soil or sand sample is provided in the Examples. In some aspects, a WDPT of 5 seconds indicates that a water drop evaporates before moving into the soil. In some aspects, the WDPT of the fertilizer can be maintained at a high level for up to a period of about 11 weeks. In one aspect, the slow-release organic fertilizer has a pH of about 6.3 and an organic matter content of from about 0.5% to about 75%, or from about 0.5% to about 50%, from about 0.5% to about 10%, or from about 0.5% to about 1%, or of about 0.68%. In an aspect, the slow-release fertilizer has a saturated hydraulic conductivity of at least about 91.4 cm/h, where methods for measuring saturated hydraulic conductivity can be found in the Examples.

In any of these aspects, the slow-release fertilizer has a sodium level of from about 30% to about 50% of the sodium level in an otherwise identical composition that has not been subjected to heat treatment, or about 30, 35, 40, 45, or about 50% of the sodium level, of a combination of any of the foregoing values, or a range encompassing any of the foregoing values. In another aspect, the slow-release fertilizer has a calcium level of from about 120% to about 160% of the calcium level in an otherwise identical composition that has not been subjected to heat treatment, or about 120, 125, 130, 135, 140, 145, 150, 155, or about 160% of the calcium level, of a combination of any of the foregoing values, or a range encompassing any of the foregoing values.

In still another aspect, a leachate from the slow-release fertilizer has a nitrate level of from about 150% to about 200% relative to a nitrate level in a leachate from an otherwise identical composition that has not been subjected to heat treatment, or about 150, 155, 160, 165, 170, 175, 180, 185, 190, 195, or about 200% of the nitrate level, of a combination of any of the foregoing values, or a range encompassing any of the foregoing values. In still another aspect, a leachate from the slow-release fertilizer has an ammonia level of from about 125% to about 160% relative to an ammonia level in a leachate from an otherwise identical composition that has not been subjected to heat treatment, or about 125, 130, 135, 140, 145, 150, 155, or about 160% of the ammonia level, of a combination of any of the foregoing values, or a range encompassing any of the foregoing values.

In one aspect, the slow-release fertilizer includes an increased level of at least one amino acid compared to an otherwise identical fertilizer that has not been heat treated. Further in this aspect, the amino acid can be a proteinogenic amino acid or a non-proteinogenic amino acid such as, for example, cysteine, methionine, lysine, alanine, aspartic acid, glutamic acid, glycine, isoleucine, leucine, proline, threonine, valine, arginine, histidine, phenylalanine, serine, tyrosine, tryptophan, hydroxylysine, hydroxyproline, lanthionine, ornithine, taurine, or any combination thereof. In one aspect, the increased level can be from about 125% to about 200% of a level of an otherwise identical fertilizer that has not been heat treated.

In an aspect, the disclosed compositions can be used to improve transplant success of a plant. Further in this aspect, growth of the plant can be initiated in a medium containing the slow-release fertilizer and the plant can then be transplanted at seedling stage into a second medium. In a further aspect, improved transplant success can be measured by assessing whether increased percent cover for a ground cover plant, root length, root area, shoot length, shoot area, number of shoots, or any combination thereof, has occurred and comparing the same to those values for an otherwise identical plant that has not been treated by the method.

In one aspect, the disclosed compositions can be used to improve the growth of a plant, where improved growth can be assessed any number of ways including, but not limited to, increased percent cover for a ground cover plant, increased root length, root area, shoot length, shoot area, number of shoots, other properties, and combinations thereof, when the plant is compared to an otherwise identical plant that has not been grown in the presence of the slow-release fertilizer. In one aspect, growth can be increased by applying the slow-release fertilizer to soil in which the plant is growing.

In a further aspect, also disclosed herein are plants treated by the disclosed methods, including, but not limited to, ground cover plants such as, for example, Bermudagrass. However, the disclosed method is not exclusive and other types of plants should also be considered disclosed. In an aspect, when the plant is a grass or ground cover plant, the ground cover plant can have a percent cover of from about 90% to about 100% by root zone after 4 months. In another aspect, the ground cover plant can have larger roots as measured by one or more of length, surface area, average diameter, density, volume, and total dry weight compared to an otherwise identical ground cover plant that has not been treated using the method. In still another aspect, plants treated by the disclosed method have a more intense color indicative of higher levels of photosynthesis.

In some aspects, the disclosed methods can be useful for establishing crops during drought, areas of high wind, or in other low-water conditions. In one aspect, and without wishing to be bound by theory, although initial establishment of plants may be slower when using the disclosed method due to increased hydrophobicity of the substrates, over time plants established in the disclosed substrates can have substantially better root growth, shoot growth, photosynthesis, and other similar properties.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a sand,” “a plant,” or “an average diameter,” includes, but is not limited to, mixtures or combinations of two or more such sands, plants, or average diameters, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x,’ ‘about y’, and ‘about z’ as well as the ranges of ‘less than x’, less than y′, and ‘less than z’. Likewise, the phrase ‘about x, y, z, or greater’ should be interpreted to include the specific ranges of ‘about x,’ ‘about y,’ and ‘about z’ as well as the ranges of ‘greater than x,’ greater than y,′ and ‘greater than z.’ In addition, the phrase “about ‘x’ to ‘y”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of peat refers to an amount that is sufficient to achieve the desired improvement in the property modulated by the formulation component, e.g. achieving the desired level of water repellency in a sand or soil. The specific level in terms of wt % in a composition required as an effective amount will depend upon a variety of factors including the amount and average diameter of filler material or sand particles mixed with the peat, amount and type of peat, heating temperature and time, and particular plant or plants being grown in the soil.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered aspects, which should not be confused with the claims.

Aspect 1. A method for creating a slow-release fertilizer, the method comprising:
(a) heating a composition comprising peat to an elevated temperature; and
(b) allowing the composition to cool to ambient temperature, thereby creating the fertilizer.

Aspect 2. The method of aspect 1, wherein the composition further comprises a filler material.

Aspect 3. The method of aspect 1, wherein following step (b), the method further comprises blending the fertilizer with a filler material.

Aspect 4. The method of aspect 2 or 3, wherein the filler material comprises sand, perlite, vermiculite, limestone, or any combination thereof.

Aspect 5. The method of aspect 3 or 4, wherein the sand has an average particle diameter of about 0.5 mm.

Aspect 6. The method of any one of aspects 1-5, wherein the peat comprises reed sedge peat, sphagnum peat, Latvian peat, Florida peat, or any combination thereof.

Aspect 7. The method of any one of aspects 1-6, wherein the elevated temperature is from about 175° C. to about 200° C.

Aspect 8. The method of any one of aspects 1-7, wherein the composition in step (a) is heated in an oven.

Aspect 9. The method of any one of aspects 1-8, wherein the fertilizer comprises from about 75% to about 99.5% (v/v) of filler material and from about 0.5% to about 25% (v/v) of peat.

Aspect 10. A slow-release fertilizer produced by the method of any one of aspects 1-9.

Aspect 11. The slow-release fertilizer of aspect 10, wherein the slow-release fertilizer is natural, organic, or both natural and organic.

Aspect 12. The slow-release fertilizer of aspect 10 or 11, wherein the slow-release fertilizer is hydrophobic.

Aspect 13. The slow-release fertilizer of any one of aspects 10-12, wherein the slow-release fertilizer has a water drop penetration time of at least 5 seconds.

Aspect 14. The slow-release fertilizer of aspect 13, wherein the slow-release fertilizer maintains the water drop penetration time for at least about 11 weeks.

Aspect 15. The slow-release fertilizer of any one of aspects 10-14, wherein the slow-release fertilizer has a pH of about 6.3.

Aspect 16. The slow-release fertilizer of any one of aspects 10-15, wherein the slow-release fertilizer comprises from about 0.5% to about 75% organic matter.

Aspect 17. The slow-release fertilizer of any one of aspects 10-16, wherein the slow-release fertilizer has a sodium level of from about 30% to about 40% of a sodium level in an otherwise identical composition that has not been subjected to heat treatment.

Aspect 18. The slow-release fertilizer of any one of aspects 10-17, wherein the slow-release fertilizer has a calcium level of from about 125% to about 160% of a calcium level in an otherwise identical composition that has not been subjected to heat treatment.

Aspect 19. The slow-release fertilizer of any one of aspects 10-18, wherein a leachate from the slow-release fertilizer has a nitrate level of from about 150% to about 200% of a nitrate level in a leachate from an otherwise identical composition that has not been subjected to heat treatment.

Aspect 20. The slow-release fertilizer of any one of aspects 10-19, wherein a leachate from the slow-release fertilizer has an ammonia level of from about 125% to about 160% of an ammonia level in a leachate from an otherwise identical composition that has not been subjected to heat treatment.

Aspect 21. The slow-release fertilizer of any one of aspects 10-20, wherein the slow-release fertilizer comprises an increased level of at least one amino acid compared to an otherwise identical fertilizer that has not been heat treated.

Aspect 22. The slow release fertilizer of aspect 21, wherein the amino acid comprises cysteine, methionine, lysine, alanine, aspartic acid, glutamic acid, glycine, isoleucine, leucine, proline, threonine, valine, arginine, histidine, phenylalanine, serine, tyrosine, tryptophan, hydroxylysine, hydroxyproline, lanthionine, ornithine, taurine, or any combination thereof.

Aspect 23. The slow-release fertilizer of any one of aspects 10-22, wherein the slow-release fertilizer has a saturated hydraulic conductivity of about 91.4 cm/h.

Aspect 24. A method for improving transplant success of a plant, the method comprising:
(a) initiating growth of the plant in a medium comprising the slow-release fertilizer of any one of aspects 10-23; and
(b) transplanting the plant at seedling stage into a second medium.

Aspect 25. The method of aspect 24, wherein improving transplant success of a plant comprises increased percent cover for a ground cover plant, root length, root area, shoot length, shoot area, number of shoots, or any combination thereof, compared to an otherwise identical plant that has not been treated by the method.

Aspect 26. A method for improving growth of a plant, the method comprising applying the slow-release fertilizer of any one of aspects 10-23 to soil in which the plant is growing.

Aspect 27. The method of aspect 26, wherein improving the growth of a plant comprises increased percent cover for a ground cover plant, root length, root area, shoot length, shoot area, number of shoots, or any combination thereof, compared to an otherwise identical plant that has not been treated by the method.

Aspect 28. A plant treated by the method of aspect 26 or 27.

Aspect 29. The plant of aspect 28, wherein the plant is a ground cover plant.

Aspect 30. The plant of aspect 29, wherein the ground cover plant is Bermudagrass.

Aspect 31. The method of aspect 29 or 30, wherein the ground cover plant has a percent cover of from about 90% to about 100% by root zone after 4 months.

Aspect 32. The method of any one of aspects 29-31, wherein the ground cover plant has larger roots as measured by one or more of length, surface area, average diameter, density, volume, and total dry weight compared to an otherwise identical ground cover plant that has not been treated using the method.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Materials and Methods

### Location

This study was conducted at the University of Florida's Institute of Food and Agricultural Sciences, at the Fort Lauderdale Research and Education Center, in Davie, FL.

### Soap Method

IVORY® bar soap (available from Proctor and Gamble, Corp.; Cincinnati, OH; ingredients: sodium tallowate and/or sodium palmate, water, sodium cocoate and/or sodium palm kernelate, glycerin, sodium chloride, fragrance, coconut acid*, palm kernel acid*, tallow acid*, palm acid*, tetrasodium EDTA [*contains one or more of these ingredients]) was used to make a soap or stearic acid solution to hydrophobize sand. Five grams of IVORY® bar soap and 500 ml of deionized water were placed in a bowl and heated inside a laboratory microwave (1000 watts) for 140 seconds to completely dissolve the soap. An additional 500 mL of deionized water was added to the microwaved stearic acid solution. One 22.6 kg bag of coarse sand (Florida Silica Sand; Miami, FL) was poured into a small, portable cement mixer followed-by the 1000 mL stearic acid solution being poured onto the sand. The sand and solution were blended for ten minutes until the sand appeared thoroughly and completely wetted. The coated sand was poured into 30 cm length×23 cm width×10.25 cm depth aluminum pans until half-full, then oven-dried for four hours at 65° C. After cooling to ambient temperature, the coated sand was tested for water repellency, and was found to be severely water repellent (water drop penetration time ≥600 seconds) according to a procedure described in the literature. The final product was hydrophobic soap coated sand (HSS).

### Sand and Reed Sedge Peat Method

A 90:10% v/v blend of coarse sand (Florida Silica Sand; Miami, FL) and reed sedge peat (Dakota Peat and Equipment, Inc., Grand Forks, ND) were placed in a small cement mixer and blended until thoroughly and uniformly mixed. The sand and peat mixture were placed into 30 cm length×23 cm width×10.25 cm depth aluminum pans until half full. The pans were placed in 180° C. oven for two hours. After this mixture cooled, it was tested for water repellency, and found to be severely water repellent (a water drop penetration time ≥600 seconds) according to a procedure described in the literature. The final product was a hydrophobic sand and reed sedge peat mixture (HSP).

### Duration of Hydrophobicity

Plastic containers (3.75 cm×20.65 cm) were filled with either HSS (n=33) or HSP (n=33) and placed inside a greenhouse on a bench under misters that irrigated the containers with 62.5 mm water·day 1. Each week, for eleven continuous weeks, three containers of each HSS and HSP were removed to measure water repellency using a laboratory test for water drop penetration time (WDPT).

The HSS and HSP samples were placed on a laboratory benchtop and allowed to dry at room temperature for at least 14 days. Next, a 35 μL pipette was filled with deionized water, and one drop placed on the surface of all samples. A stopwatch was used to record length of time for the entire drop to penetrate completely into the sand surface, and WDPT was recorded in seconds. Only one WDPT measurement was conducted per sample. After obtaining WDPT on the surface of each sample, the container was carefully emptied onto a bench to measure WDPT at approximately one to six cm depths. A 35 μL water drop was placed at every one-centimeter depth to determine WDPT per depth. Of note, WDPT measurements were halted at 600 seconds and time was recorded. The severity of repellency was based on classification described in the literature (Table 1).

TABLE 1
Classification System for Water-Repellent Soils
Based on Water Drop Penetration Time (WDPT)

| Class | Time (s) | Classification^{[a]} |
|---|---|---|
| 0 | <5 | Wettable |
| 1 | 5-60 | Slightly water repellent |
| 2 | 60-600 | Strongly water repellent |
| 3 | 600-3600 | Severely water repellent |
| 4 | 1-3 h | Extremely water repellent |
| 5 | 3-6 h | Extremely water repellent |
| 6 | >6 h | Extremely water repellent |

^{[a]}Dekker, L.W. et al., 2009.

### Turfgrass Establishment

Peat, in general, is used in the horticultural substrate market as component of soilless substrate mixes. The preference for peat is due to its water holding capacity, nutrient holding capacity, low pH and high cation exchange capacity.

For each of two greenhouse experiments conducted, polyvinyl chloride lysimeters (7.6 cm diam×30.5 cm length) were assembled and filled with either two hydrophilic (wettable) root zone substrates, or two hydrophobic (water repellent) root zone substrates. The wettable root zone treatments were WSAND (100% wettable sand; Florida Silica Sand, Miami, FL) or WSP (90:10% v/v wettable sand:peat). The hydrophobic root zone treatments were HSP (hydrophobic sand and reed sedge peat mixture), or HSS (hydrophobic soap coated sand). Representative substrate samples were sent to a laboratory (Hummel and Company, Trumansburg, NY) for physical and chemical analysis (Tables 3 and 4).

In additional experiments, Dakota reed sedge peat was heated at 180° C. in an oven then mixed with sand at 90/10 sand/heated peat v/v rate (HSP). This mix was severely hydrophobic. It was compared to an 90/10 unheated peat/sand v/v (WSP), a common mixture found in golf course greens. Mixtures were placed in PVC lysimeters and “Tifeagle” bermudagrass pelts were planted. Experiment One was run for 52 days and despite the severe hydrophobicity, HSP was similar to WSP (Table 7). When the trial was run for 132 days (Table 8), the HSP significantly increased root length, surface area, density, volume, total dry weights of roots as well shoot count. In fact, root length doubled in the HSP treatment.

Root zone substrates were firmly packed into the lysimeters and sprigged at a rate of 20.0 gm² bermudagrass (cv. ‘Tifeagle’) per column. A complete fertilizer (24N-8P₂O₅-16K₂O) (Miracle-Gro Water Soluble All Purpose Plant Food, Scotts-MiracleGro, Marysville, OH) was applied weekly at a rate of 2.4 g N·m⁻². During the establishment phase, 25.0 mm of total irrigation throughout the day was applied via pop-up misters. Experiment One was initiated on 16 May 2013, and visual assessment of percent surface area covered with bermudagrass was recorded approximately every 10 days for the 52-day duration of this experiment. Experiment Two was initiated on 8 Oct. 2013, and percent cover ratings were recorded initially every 7 to 14 days for the 132-day duration of this experiment. Visual bermudagrass cover ratings ceased when all treatments reached ≥90% surface area covered.

At the conclusion of both experiments, columns were deconstructed to determine bermudagrass shoot counts (i.e., total number of shoots per surface area of column) and roots were analyzed using WinRHIZO PRO v. 2009 (Regent Instruments Inc. Ottawa, ON, Canada). Also for both experiments, water repellency was determined via WDPT. The recorded WDPT for each root zone substrate was the average of 5 measurements obtained uniformly throughout top-half of the soil column. Therefore, WDPT data were representative of soil water repellency for the 0-15 cm root zone depth.

### Experimental Design and Statistical Analysis

For the duration of hydrophobicity experiment, all samples were arranged as a randomized complete block with four replicates, and WDPT data were subjected to analysis of variance using PROC GLM (Statistical Analysis Software, v. 9.3; Cary, NC, USA) with treatment means compared using Tukey's multiple range test at p≤0.05. For both turfgrass establishment experiments, treatments were arranged in a complete randomized block design with four replications, and all data were subjected to analysis of variance using PROC GLM (Statistical Analysis Software, v. 9.3; Cary, NC, USA) and treatment means compared using preplanned orthogonal contrasts at p≤0.05.

### Example 2: Results and Discussion

### Substrate Particle Size Analysis

All four root zone substrates—WSAND, WSP, HSS, and HSP—contained ≥98.9% sand, ≤0.5% silt, and ≤0.7% clay (Table 2). With the sand component, all four substrates contained ≥77.7% coarse sand fraction (Table 2). Soils with less total surface per area on a volume basis or coarse textured sand soils are more likely to be water repellent then clay soils with larger surface area.

TABLE 2
Particle Size Analysis for Root Zone Substrates Used in Experiments One and Two

| | | | | Sieve size | | | | | | |
|---|---|---|---|---|---|---|---|---|---|---|
| | | | | Sand fraction | | | | | | |
| | | | | Sand particle diameter | | | | | | |
| | | | | No. 10 | No. 18 | No. 35 | No. 60 | No. 100 | No. 140 | No. 270 |
| | Soil separate | | | Gravel | V. Coarse | Coarse | Medium | Fine | V. Fine | V. Fine |
| | Sand | Silt | Clay | 2 mm | 1 mm | 0.5 mm | 0.25 mm | 0.15 mm | 0.10 mm | 0.05 mm |
| Substrate^{[a]} | % | | | % retained | | | | | | |
| WSAND | 99.3 | 0.2 | 0.5 | 0.0 | 6.9 | 80.0 | 11.7 | 0.6 | 0.0 | 0.1 |
| WSP | 98.9 | 0.5 | 0.6 | 0.0 | 6.5 | 78.0 | 13.2 | 1.0 | 0.1 | 0.1 |
| HSS | 99.6 | 0.0 | 0.4 | 0.0 | 8.3 | 80.3 | 10.7 | 0.3 | 0.0 | 0.0 |
| HSP | 99.0 | 0.3 | 0.7 | 0.0 | 5.8 | 77.7 | 14.2 | 1.1 | 0.1 | 0.1 |

^{[a]}Root zone substrate: WSAND (100% wettable sand); WSP (90:10% v/v wettable sand:peat); HSS (hydrophobic soap coated sand); HSP (90:10% v/v hydrophobic sand:peat mixture).

### Substrate Chemical and Physical Characteristics

Substrate pH was considered suitable for turfgrass at 7.2, 6.4, 6.9, and 6.3 for WSAND, WSP, HSS, and HSP, respectively (Table 3). Organic matter content was 0.04 and 0.06% for WSAND and WSP, respectively, and 0.81 and 0.68% for WSP and HSP, respectively (Table 3). For all substrates, bulk density ranged from 1.67 to 1.69 g*cm³, and particle density ranged from 2.63 to 2.65 g·cm³ (Table 3). Saturated hydraulic conductivity was higher with WSAND and HSS at 129.3 and 119.6 cm·hr⁻¹, respectively, compared to 73.1 and 91.4 cm·hr⁻¹ for WSP and HSP, respectively (Table 3). Of note, hydrophobic sand (˜HSS) exhibited similar infiltration or measured saturated hydraulic conductivity as wettable sand (˜WSAND). For all substrates, total porosity ranged from 36.4 to 36.7%, and aeration porosity ranged from 27.5 to 32.1% (Table 3).

TABLE 3
Chemical and Physical Characteristics of Substrates

| | | | | | Saturated | | |
|---|---|---|---|---|---|---|---|
| | | Organic | Bulk | Particle | hydraulic | Total | Aeration |
| | | matter | density | Density | conductivity | porosity | porosity |
| Substrate^{[a]} | pH | (%) | (cm⁻³) | (g · cm⁻³) | (cm · hr⁻¹) | (%) | (%) |
| WSAND | 7.2 | 0.04 | 1.69 | 2.65 | 129.3 | 36.4 | 31.4 |
| WSP | 6.4 | 0.81 | 1.67 | 2.63 | 73.1 | 36.4 | 27.5 |
| HSS | 6.9 | 0.06 | 1.68 | 2.65 | 119.6 | 36.7 | 32.1 |
| HSP | 6.3 | 0.68 | 1.67 | 2.63 | 91.4 | 36.7 | 29.9 |

^{[a]}Root zone substrate: WSAND (100% wettable sand); WSP (90:10% v/v wettable sand:peat); HSS (hydrophobic soap coated sand); HSP (90:10% v/v hydrophobic sand:peat mixture).

### Substrate Duration of Hydrophobicity

With both HSS and HSP, WDPTs were not recorded for more than 600 sec (Table 4) as that is considered severely water repellent. At the start of the evaluation period (i.e., week zero), HSS and HSP were severely water repellent at all depths including the air-surface interface of 0 cm depth (Table 4). At week one, WDPT at 0 cm was severely water repellent for HSS and strongly water repellent for HSP, at 600 and 479.7 sec, respectively (Table 4). At weeks two and three, WDPT at 0 cm was slightly water repellent for both HSS and HSP (Table 4). At weeks four through eleven, WDPT at 0 cm was considered wettable overall for both HSS and HSP (Table 4). At only week six, eight, and nine, HSP was significantly more hydrophobic compared to HSS, however, WDPTs for both were ≤5.8 to 0.0 sec, respectively (Table 4). At the 0 cm depth (i.e., surface interface), the wettability or lack of water repellency may be explained by the repeated impact of fine water drops from overhead irrigation that perhaps degraded the hydrophobic coating. At depths of one through six cm, HSS and HSP were severely water repellent as maintained under greenhouse conditions for the duration of the eleven-week evaluation period (Table 4).

TABLE 4
Duration of Hydrophobicity by Root Zone Depth for Hydrophobic Soap-Coated
Sand (HSS) and a Hydrophobic 90:10% (v/v) Blend of Coarse Sand and
Reed Sedge Peat (HSP) as Determined by Water Drop Penetration Time

| | Week | | | | | | | | | | | |
|---|---|---|---|---|---|---|---|---|---|---|---|---|
| | 0 | 1 | 2 | 3 | 4 | 5 | 6 | 7 | 8 | 9 | 10 | 11 |
| Sand | Water drop penetration time (sec)^{[a]} | | | | | | | | | | | |
| | 0 cm depth | | | | | | | | | | | |
| HSS | 600 | 600 | 33.1 | 15.0 | 2.3 | 3.3 | 0.0 | 0.0 | 0.0 | 0.0 | 0.0 | 0.0 |
| HSP | 600 | 479.7 | 33.3 | 16.7 | 6.0 | 4.8 | 5.8 | 1.0 | 2.2 | 3.0 | 1.0 | 0.3 |
| | ns^{[y]} | ns | ns | ns | ns | ns | * | ns | * | * | ns | ns |
| | 1 cm depth | | | | | | | | | | | |
| HSS | 600 | 600 | 600 | 600 | 600 | 600 | 600 | 600 | 600 | 600 | 600 | 600 |
| HSP | 600 | 600 | 600 | 600 | 600 | 600 | 600 | 600 | 600 | 600 | 600 | 600 |
| | ns | ns | ns | ns | ns | ns | ns | ns | ns | ns | ns | ns |
| | 2 cm depth | | | | | | | | | | | |
| HSS | 600 | 600 | 600 | 600 | 600 | 600 | 600 | 600 | 600 | 600 | 600 | 600 |
| HSP | 600 | 600 | 600 | 600 | 600 | 600 | 600 | 600 | 600 | 600 | 600 | 600 |
| | ns | ns | ns | ns | ns | ns | ns | ns | ns | ns | ns | ns |
| | 3 cm depth | | | | | | | | | | | |
| HSS | 600 | 600 | 600 | 600 | 600 | 600 | 600 | 600 | 600 | 600 | 600 | 600 |
| HSP | 600 | 600 | 600 | 600 | 600 | 600 | 600 | 600 | 600 | 600 | 600 | 600 |
| | ns | ns | ns | ns | ns | ns | ns | ns | ns | ns | ns | ns |
| | 4 cm depth | | | | | | | | | | | |
| HSS | 600 | 600 | 600 | 600 | 600 | 600 | 600 | 600 | 600 | 600 | 600 | 600 |
| HSP | 600 | 600 | 600 | 600 | 600 | 600 | 600 | 600 | 600 | 600 | 600 | 600 |
| | ns | ns | ns | ns | ns | ns | ns | ns | ns | ns | ns | ns |
| | 5 cm depth | | | | | | | | | | | |
| HSS | 600 | 600 | 600 | 600 | 600 | 600 | 600 | 600 | 600 | 600 | 600 | 600 |
| HSP | 600 | 600 | 600 | 600 | 600 | 600 | 600 | 600 | 600 | 600 | 600 | 600 |
| | ns | ns | ns | ns | ns | ns | ns | ns | ns | ns | ns | ns |
| | 6 cm depth | | | | | | | | | | | |
| HSS | 600 | 600 | 600 | 600 | 600 | 600 | 600 | 600 | 600 | 600 | 600 | 600 |
| HSP | 600 | 600 | 600 | 600 | 600 | 600 | 600 | 600 | 600 | 600 | 600 | 600 |
| | ns | ns | ns | ns | ns | ns | ns | ns | ns | ns | ns | ns |

^{[a]}Dekker, L. W., C. J. Ritsema, K. Oostindie, D. Moore and J. G. Wesseling. 2009. Methods for determining soil water repellency on field-moist samples. Water Resources Research 45: W00D33.
^{[b]} Not statistically significant (ns) or statistically significant (*) when comparing data means (n = 4) with Tukey's Multiple Range Test at p ≤ 0.05.

The WDPT results indicate that under greenhouse conditions with overhead irrigation supplied to bare or exposed HSS or HSP, both the HSP and HSS at 0 cm were severely to strongly water repellent for the first two weeks, slightly water repellent for the next two weeks, and wettable for the remaining seven weeks (Table 4). The severely water repellent WDPTs for both HSS and HSP at the one through six cm depths were similar to extremely water repellent WDPTs measured on both a 10 g·kg⁻¹ and 30 g·kg⁻¹ stearic acid treated silica sand. Of note, HSP had not been evaluated prior to this evaluation for longevity of water repellency. Thus, both HSS and HSP maintained severe hydrophobicity under daily irrigation and greenhouse conditions at the one to six cm depths for eleven continuous weeks (i.e., 77 days).

### Bermudagrass Establishment Experiments: Cover

Bermudagrass cover for all substrates was 2% at the start of the Experiment One (Table 5). Bermudagrass cover in WSAND was not significantly different versus HSS throughout the experiment, with a final cover of 33.1% for WSAND and 29.4% HSS (Table 5). Bermudagrass cover for WSP was significantly higher versus HSP from 15 through 52 days of the experiment, with a final cover of 72.2% for WSP and 45.9% HSP (Table 5).

TABLE 5
Bermudagrass Cover by Root Zone Substrate
Over Time in Experiment One

| | Days after sprigging^{[b]} | | | | | |
|---|---|---|---|---|---|---|
| Substrate^{[a]} | 1 | 15 | 24 | 35 | 46 | 52 |
| | Percent cover^{[c]} | | | | | |
| WSAND | 2.0 | 2.6 | 3.5 | 6.8 | 17.8 | 33.1 |
| WSP | 2.0 | 11.8 | 12.9 | 19.1 | 54.4 | 72.2 |
| HSS | 2.0 | 2.2 | 3.6 | 5.9 | 19.7 | 29.4 |
| HSP | 2.0 | 5.5 | 3.6 | 10.3 | 27.2 | 45.9 |
| | Contrasts^{[d]} | | | | | |
| WSAND vs. HSS | ns | ns | ns | ns | ns | ns |
| WSP vs. HSP | ns | ** | ** | * | ** | ** |

^{[a]}Root zone substrate: WSAND (100% wettable sand); WSP (90:10% v/v wettable sand:peat); HSS (hydrophobic soap coated sand); HSP (90:10% v/v hydrophobic sand:peat mixture).
^{[b]}Bermudagrass (‘Tifeagle’) sprigs established on 16 May 2013 and experiment maintained under greenhouse conditions.
^{[c]}Percent cover of 7.6 cm diam area on a 0-100 scale, where 0 = no cover, 100 = complete cover.
^{[d]}ns, *, and ** = not significant or significant at p ≤ .05 and p ≤ .01, respectively.

In Experiment Two, bermudagrass cover for all substrates also was 2% at the start (Table 6). Cover assessment did not start until most substrates exhibited about 20% cover (Table 6). Bermudagrass cover for WSAND was not significantly different versus HSS throughout most of the experiment, except at day 35 with 46.3% cover for WSAND significantly higher versus 32.5% cover for HSS (Table 6). Final cover for WSAND was 92.5% and 91.3% for HSS (Table 6). Bermudagrass cover for WSP was not significantly different versus HSP during most of the experiment, except at day 27 and 35 (Table 6). On day 27, cover for WSP was significantly higher versus HSP at 56.3% versus 41.5%, respectively (Table 6). On day 35, cover for WSP also was significantly higher versus HSP at 73.8% versus 48.7%, respectively (Table 6). Final cover for WSP and HSP was 100.0% (Table 6).

TABLE 6
Bermudagrass Cover by Root Zone Substrate Over Time in Experiment Two

| | Days after sprigging^{[b]} | | | | | | | | | | |
|---|---|---|---|---|---|---|---|---|---|---|---|
| Substrate^{[a]} | 1 | 20 | 27 | 35 | 42 | 48 | 56 | 70 | 87 | 115 | 132 |
| | Percent cover^{[c]} | | | | | | | | | | |
| WSAND | 2.0 | 22.5 | 27.5 | 46.3 | 52.5 | 53.8 | 47.5 | 57.5 | 67.5 | 82.5 | 92.5 |
| WSP | 2.0 | 31.3 | 56.3 | 73.8 | 82.5 | 83.7 | 81.2 | 90.0 | 93.8 | 100.0 | 100.0 |
| HSS | 2.0 | 18.7 | 20.0 | 32.5 | 42.5 | 42.5 | 48.7 | 56.2 | 61.3 | 73.8 | 91.3 |
| HSP | 2.0 | 27.5 | 41.5 | 48.7 | 72.5 | 78.7 | 83.7 | 91.2 | 92.5 | 98.7 | 100.0 |
| | Contrasts^{[d]} | | | | | | | | | | |
| WSAND | ns | ns | ns | * | ns | ns | ns | ns | ns | ns | ns |
| vs. HSS | | | | | | | | | | | |
| WSP vs. | ns | ns | * | ** | ns | ns | ns | ns | ns | ns | ns |
| HSP | | | | | | | | | | | |

^{[a]}Root zone substrate: WSAND (100% wettable sand); WSP (90:10% v/v wettable sand:peat); HSS (hydrophobic soap coated sand); HSP (90:10% v/v hydrophobic sand:peat mixture).
^{[b]}Bermudagrass (‘Tifeagle’) sprigs established on 8 Oct. 2013 and experiment maintained under greenhouse conditions.
^{[c]}Percent cover of 7.6 cm diam area on a 0-100 scale, where 0 = no cover, 100 = complete cover.
^{[d]}ns, *, and ** = not significant or significant at p ≤ .05 and p ≤ .01, respectively.

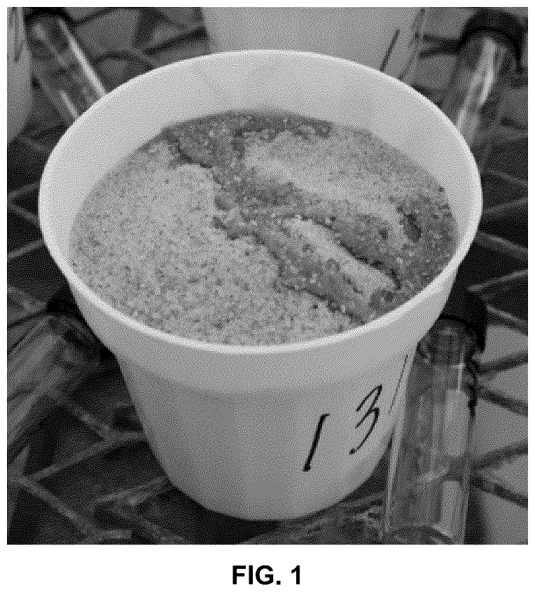

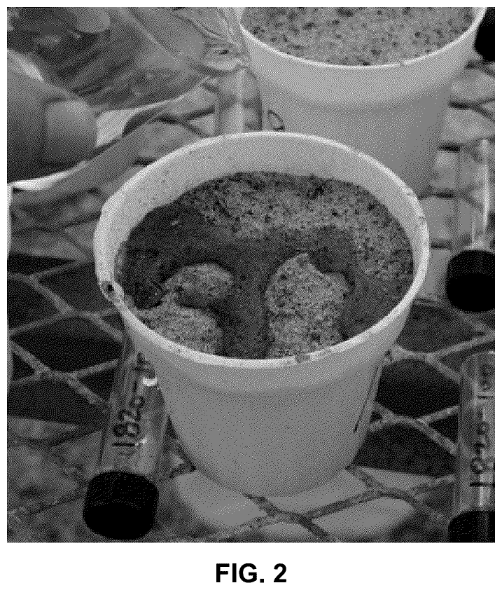

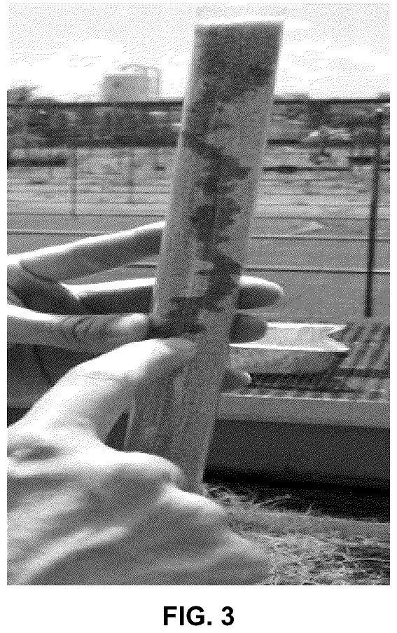

In both experiments, perhaps the higher organic matter content and the lower saturated hydraulic conductivity in WSP and HSP provided better nutrient and water retention than WSAND and HSS and therefore better establishment and subsequent growth and coverage of bermudagrass (Tables 3, 5, and 6). Establishment and cover results demonstrate HSS and HSP did not injure or kill the bermudagrass sprigs, and therefore were not considered phytotoxic to bermudagrass as established from sprigs. As reported in previous research, soil water repellency deterred establishment of perennial ryegrass (Lolium perenne L.) seed and rangeland grasses mainly by reducing water infiltration and moisture availability to the plant, which also may explain low establishment in WSAND. Since substrate root zone moisture could not be evaluated during the establishment experiments, it is likely that the water repellent or hydrophobic properties of HSS and HSP were contributing factors to reduced bermudagrass cover. As little as 3% w/w of hydrophobic particles may reduce wetting of the soil and increase the likelihood of preferential flow path formation. As seen by the lack of infiltration in both HSS and HSP (FIGS. 1 and 2), preferential flow paths may have formed on the sides of the columns (FIG. 3) as a result of the hydrophobic properties of those two substrates.

Therefore, this lack of water infiltration throughout the profile may have initially hindered or slowed bermudagrass establishment in the severely water repellent HSS and HSP when compared to the wettable WSAND and WSP. It was not feasible for root zone volumetric water content data to be collected during the experiment. It is possible the low moisture holding capacity of sand root zones and their high infiltration rates, whether in a hydrophobic or hydrophilic substrate, negatively affected bermudagrass establishment. Differences among the hydrophobic substrates may be attributed to their higher organic matter content (Table 3). As reported previously, the addition of clay increases surface area of sand grains and may cover hydrophobic areas on the sand grain, rendering the sand hydrophilic and also increasing water retention.

A benefit of adding peat to a sand root zone is to increase moisture retention. Improved creeping bentgrass (Agrostis stolonifera L.) establishment in organic-amended root zones when compared to inorganic-amended rootzones has also been reported. The higher organic matter content (Table 3) in WSP and HSP may have provided more plant available moisture to the bermudagrass versus WSAND and HSS. Thus, the organic matter content may have provided an additional benefit to the bermudagrass grown in WSP and HSP as faster establishment and 100% cover was achieved by the end of Experiment Two (Table 6).

### Bermudagrass Establishment Experiments: Root Analysis

Root length, surface area, diameter, density, volume, and weight were all measured at the conclusion of each experiment (Tables 7 and 8). In Experiment One, bermudagrass root length, surface area, density, volume, and total dry weight were significantly higher in WSAND versus HSS (Table 7). Similarly, water repellent soil and soil moisture stress negatively affect turfgrass rooting. The possible reduced water and nutrient retention in WSAND and HSS could negatively affect root growth in those two substrates and added stress of soil water repellency in HSS was most likely another contributing factor to poor root growth. No significant differences with root measurements, however, were observed with WSP versus HSP (Table 7).

TABLE 7
Root Analyses and Shoot Counts of Bermudagrass for Each
Root Zone Substrate at the Conclusion of Experiment One

| | Roots^{[b]} | | | | | | |
|---|---|---|---|---|---|---|---|
| | | Surface | Average | | | Total dry | Shoots^{[b]} |
| | Length | area | diameter | Density | Volume | weight | Count |
| Substrate^{[a]} | (cm) | (cm²) | (mm) | (cm · cm⁻³) | (cm³) | (g) | (number) |
| WSAND | 2623.77 | 181.06 | 0.22 | 1.92 | 0.99 | 0.226 | 147.2 |
| WSP | 3051.65 | 220.04 | 0.23 | 2.23 | 1.27 | 0.269 | 263.3 |
| HSS | 1923.41 | 133.58 | 0.22 | 1.41 | 0.74 | 0.155 | 140.7 |
| HSP | 3266.16 | 233.69 | 0.23 | 2.39 | 1.34 | 0.263 | 268.0 |
| | Contrasts^{[c]} | | | | | | |
| WSAND vs. | ** | * | ns | * | * | *** | ns |
| HSS | | | | | | | |
| WSP vs. | ns | ns | ns | ns | ns | ns | ns |
| HSP | | | | | | | |

^{[a]}Root zone substrate: WSAND (100% wettable sand); WSP (90:10% v/v wettable sand:peat); HSS (hydrophobic soap coated sand); HSP (90:10% v/v hydrophobic sand:peat mixture).
^{[b]}Bermudagrass (‘Tifeagle’) sprigs established on 16 May 2013 and experiment maintained under greenhouse conditions for 52 days; at conclusion of experiment, roots analyzed with WinRHIZO PRO v. 2009 (Regent Instruments Inc. Ottawa, ON, Canada), and shoots visually counted as total number of shoots per 7.6 cm diam surface area.
^{[c]}ns, *, **, and *** = not significant or significant at p ≤ 0.05, p ≤ .01, and p ≤ 0.001, respectively.

In Experiment Two, bermudagrass root length was the only root measurement significantly higher in WSAND versus HSS (Table 8). Root length, surface area, density, volume, and total dry weight were all significantly lower in WSP versus HSP (Table 8). While some pronounced effects with root zone substrate and root measurements were observed in Experiment One and Experiment Two (Tables 7 and 8), the results were not consistent between the experiments. The root measurements from the two experiments may have been confounded by the duration of the study, and this reflects some of the challenges to produce an artificial system for a naturally occurring phenomenon. It is not understood whether changes in soil water repellency in some of the substrates is significantly influenced by irrigation, reorientation of hydrophobic compounds, plant species and plant establishment, or other factors.

TABLE 8
Root Analyses and Shoot Count of Bermudagrass for Each
Root Zone Substrate at the Conclusion of Experiment Two

| | Roots^{[b]} | | | | | | |
|---|---|---|---|---|---|---|---|
| | | Surface | Average | | | Total dry | Shoots^{[b]} |
| | Length | area | diameter | Density | Volume | weight | Count |
| Substrate^{[a]} | (cm) | (cm²) | (mm) | (cm · cm⁻³) | (cm³) | (g) | (number) |
| WSAND | 703.69 | 42.98 | 0.25 | 0.51 | 0.22 | 0.084 | 47.1 |
| WSP | 807.42 | 50.51 | 0.20 | 0.59 | 0.26 | 0.085 | 78.3 |
| HSS | 623.88 | 43.43 | 0.24 | 0.45 | 0.24 | 0.085 | 37.1 |
| HSP | 1629.26 | 94.81 | 0.30 | 1.19 | 0.45 | 0.153 | 123.9 |
| | Contrasts^{[c]} | | | | | | |
| WSAND vs. | * | ns | ns | ns | ns | ns | ns |
| HSS | | | | | | | |
| WSP vs. | *** | *** | ns | *** | ** | *** | *** |
| HSP | | | | | | | |

^{[a]}Root zone substrate: WSAND (100% wettable sand); WSP (90:10% v/v wettable sand:peat); HSS (hydrophobic soap coated sand); HSP (90:10% v/v hydrophobic sand:peat mixture).
^{[b]}Bermudagrass (‘Tifeagle’) sprigs established on 8 Oct. 2013 and experiment maintained under greenhouse conditions for 132 days; at conclusion of experiment, roots analyzed with WinRHIZO PRO v. 2009 (Regent Instruments Inc. Ottawa, ON, Canada), and shoots visually counted as total number of shoots per 7.6 cm diam surface area.
^{[c]}ns, *, **, and *** = not significant or significant at p ≤ 0.05, p ≤ .01, and p ≤ 0.001, respectively.

### Bermudagrass Establishment Experiments: Shoot Analysis

Turfgrass shoots and stand density are considered a reflection of turfgrass quality and health. In Experiment One, shoot growth was not significantly different in WSAND versus HSS, or in WSP versus HSP (Table 7). In Experiment Two, shoot growth again was not significantly different WSAND versus HSS, but shoot growth was lower in WSP versus HSP (Table 8).

### Bermudagrass Establishment Experiments: WDPT

At the end of Experiments One (duration=52 days) and Two (duration=132 days), WDPTs confirm WSAND and WSP remained wettable (WDPT<5 sec), HSS was slightly water repellent (WDPT 5-60 sec). HSP remained strongly water repellent (WDPT 60-600 sec) in Experiment One and slightly water repellent (WDPT 5-60 sec) in Experiment Two (Table 9).

TABLE 9
Water Drop Penetration Time (WDPT) for Root Zone Substrates
as Determined at the Conclusion of Expirements One and Two

| | WDPT | | |
|---|---|---|---|
| | Exp't One^{[b]} | Exp't Two^{[b]} | Water repellent |
| Substrate^{[a]} | -------------sec------------- | | classification^{[c]} |
| WSAND | <1.0 b^{[d]} | <1.0 b | wettable |
| WSP | 1.7 b | 2.7 b | wettable |
| HSS | 44.2 a | 31.1 a | slightly water repellent |
| HSP | 69.1 a | 32.9 a | strongly to slightly |
| | | | water repellent |

^{[a]}Root zone substrate: WSAND (100% wettable sand); WSP (90:10 % v/v wettable sand:peat); HSS (hydrophobic soap coated sand); HSP (90:10% v/v hydrophobic sand:peat mixture).
^{[b]}Experiment One initiated on 16 May 2013 and conducted for 52 days; Experiment Two initiated on 8 Oct. 2013 and conducted for 132 days.
^{[c]}Classification system for water repellent soils based on water drop penetration time (Dekker, L. W., C. J. Ritsema, K. Oostindie, D. Moore and J. G. Wesseling. 2009. Methods for determining soil water repellency on field-moist samples. Water Resources Research 45:W00D33).
^{[d]}Means (n = 5) with the same letter within a column are not significantly different according to Tukey's Multiple Range Test at p ≤ 0.05.

### Example 3: Chemical Analysis of Substrates

Chemical analysis of substrates and effects of substrates on nitrogen leaching are presented in Tables 10 and 11, respectively:

TABLE 10
Chemical Analysis of Substrates

| | | | | | | | | | | | | CEC |
|---|---|---|---|---|---|---|---|---|---|---|---|---|
| | | Organic | P | K | Ca | Mg | Na | | | | | cmol · |
| Substrate | pH | Matter % | (ppm) | (ppm) | (ppm) | (ppm) | (ppm) | % K | % Mg | % Ca | % H | kg⁻¹ |
| SAND | 7.60 | 0.10 | 16.73 | 10.50 | 104.00 | 8.25 | 110.75 | 2.50 | 6.30 | 47.48 | 0 | 1.10 |
| SP | 6.50 | 0.53 | 11.80 | 12.75 | 437.00 | 31.50 | 126.00 | 1.25 | 9.20 | 71.63 | 0 | 3.03 |
| NWRS | 7.18 | 0.78 | 73.60 | 11.75 | 506.75 | 27.25 | 38.75 | 1.03 | 7.68 | 85.45 | 0 | 2.95 |
| HSP | 6.85 | 0.55 | 13.40 | 12.75 | 620.75 | 37.75 | 43.00 | 0.90 | 8.78 | 85.08 | 0 | 3.63 |
| HSS | 7.70 | 0.13 | 32.93 | 11.00 | 280.50 | 11.00 | 29.50 | 1.83 | 5.78 | 83.43 | 0 | 1.68 |
| CC | 6.85 | 0.10 | 16.65 | 39.25 | 210.75 | 33.00 | 78.25 | 5.75 | 15.68 | 59.58 | 0 | 1.78 |

SAND = 100% hydrophilic sand
SP = 90%:10% (v/v) sand:peat
NWRS = naturally water-repellent sand
CC = 90%:10% (v/v) sand:calcined clay
Other abbreviations interpreted as above

TABLE 11
Effects of Substrates on Nitrogen Leaching with
No Plant Growth

| | NO₃ Total | NH₄ Total | NO₃ + NH₄ |
|---|---|---|---|
| Substrate | (mg · m⁻²) | (mg · m⁻²) | (mg · m⁻²) |
| SAND | 2776.7b | 41.9c | 2818.6c |
| SP | 2967.1b | 446.5b | 3413.5bc |
| HSP | 5180a | 649.3a | 5829.3a |
| CC | 4153.2a | 160.2c | 4303.8b |
| Significance | *** | *** | *** |

*** = P < 0.0001
Means with the same letter within a column are not significantly different according to Duncan's Multiple Range Test.
Fertilizer (KNO₃) was applied at a rate of 5000 mg · m⁻².

Thus, adding heated peat to sand, significantly increased the amount of plant available nitrate and ammonium which may be part of the plant response to HSP. At only 10% v/v, HSP was similar to a slow-release fertilizer.

### Example 4: Amino Acid Analysis

Heating reed sedge peat significantly increases twenty amino acids in the substrate. Amino acids are the building blocks of proteins. In soil, amino acids are a source of carbon and nitrogen and can be further broken down into nitrate, sulfate and ammonium to be utilized by plants. Plants absorb nitrogen as amino acids, nitrate ions, nitrite ions, and ammonium ions.

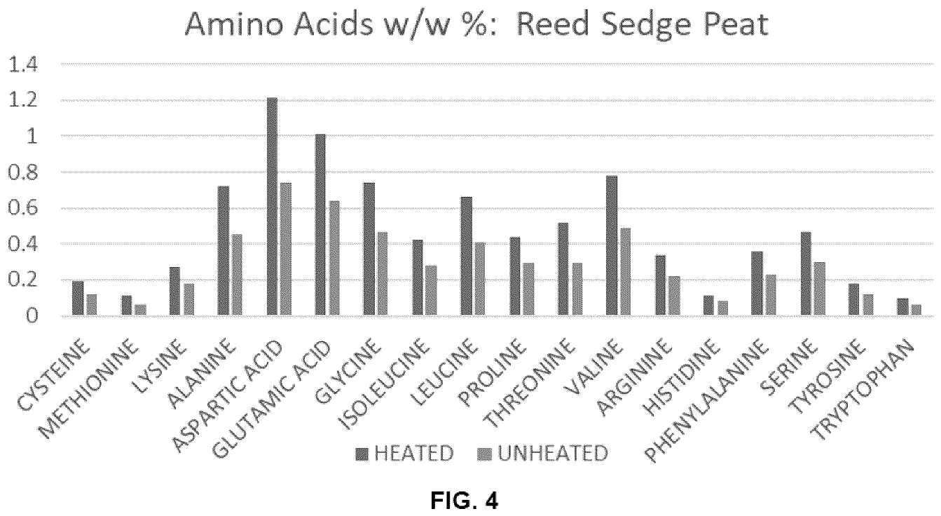

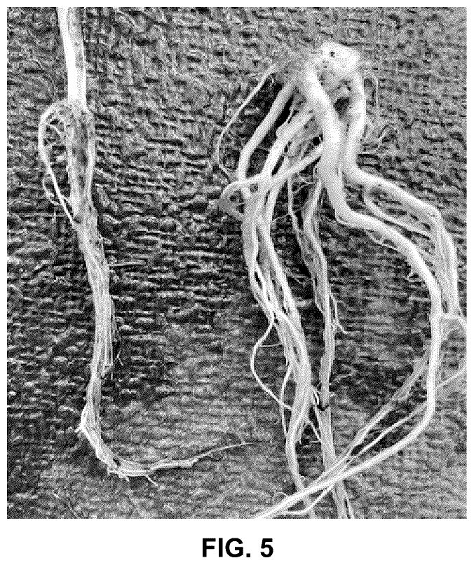

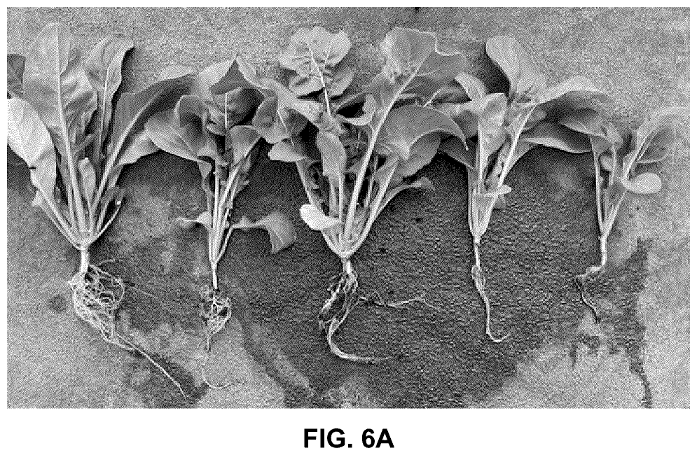

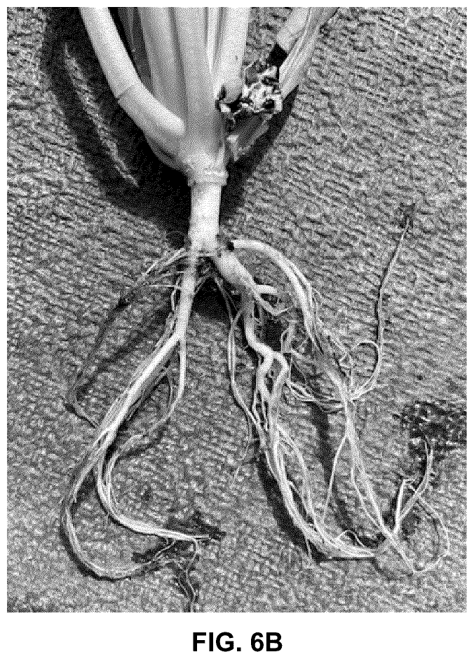

Briefly, amino acids are known to play structural, physiological and overall beneficial roles for plants. For instance, the amino acid proline is known to help plants withstand osmotic imbalance due to abiotic stresses such as drought. In fact, some products on the market promote proline for plants to help withstand salt stress. Applications of the amino acid glutamic acid, has been shown to influence the microbiota such that beneficial microbes increase and diseases that are caused by bacteria such as Fusarium decreased. Heated peat significantly increased 20 of 23 amino acids (w/w %) when compared to the unheated peat (Tables 12-13, FIG. 4).

Amino acid analysis was performed by an outside laboratory and is expressed in w/w % (grams per 100 grams of sample). Crude protein was determined by combustion analysis and reported as N %×6.25. Proteinogenic amino acids are referred to by their 3-letter codes. Non-proteinogenic and modified amino acids are referred to by the following abbreviations: HYDYL=Hydroxylysine; HYDP=Hydroxyproline; LAN=Lanthionine; ORN=Ornithine; and TAUR=Taurine. Other abbreviations in Tables 12 and 13: AA N=AA nitrogen as % of total nitrogen; M %=% Moisture; DM %=% Dry Matter; CP=Crude Protein (Nitrogen %×6.25); CPP=% Crude Protein.

TABLE 12
Amino Acid Analysis Results (w/w %) from Reed Sedge Peat

| MEDIA | CYS | MET | LYS | ALA | ASP | GLU | GLY | ILE | LEU | PRO | THR | VAL | ARG | HIS | HYDYL |
|---|---|---|---|---|---|---|---|---|---|---|---|---|---|---|---|
| HEATED | 0.19 | 0.11 | 0.27 | 0.72 | 1.21 | 1.01 | 0.74 | 0.42 | 0.66 | 0.44 | 0.52 | 0.78 | 0.34 | 0.11 | 0.0 |
| UNHEATED | 0.12 | 0.06 | 0.18 | 0.45 | 0.74 | 0.64 | 0.47 | 0.28 | 0.41 | 0.29 | 0.29 | 0.49 | 0.22 | 0.08 | 0.0 |
| SIGNIF. | *** | ** | *** | *** | *** | *** | *** | *** | *** | *** | ** | *** | *** | *** | ns |

ns, +, *, **, and *** = P > 0.10, P < 0.10, P < 0.05, P < 0.01, P < 0.0

TABLE 13
Amino Acid Analysis Results (w/w %) from Reed Sedge Peat

| MEDIA | HYDP | LAN | ORN | PHE | SER | TAUR | TYR | TRP | TOTAL | AA N | M % | DM % | CP | CPP |
|---|---|---|---|---|---|---|---|---|---|---|---|---|---|---|
| HEATED | 0.13 | 0.06 | 0.06 | 0.36 | 0.47 | 0.0 | 0.18 | 0.10 | 8.8 | 42.9 | 10.4 | 89.6 | 17.8 | 19.8 |
| UNHEATED | 0.12 | 0.05 | 0.04 | 0.23 | 0.30 | 0.0 | 0.12 | 0.06 | 5.6 | 41.2 | 45.7 | 54.3 | 10.9 | 20.1 |
| SIGNIF. | ns | ns | *** | *** | *** | ns | *** | ** | *** | *** | *** | *** | *** | *** |

ns, +, *, **, and *** = P > 0.10, P < 0.10, P < 0.05, P < 0.01, P < 0.0

Thus, in addition to slow release fertilizer characteristics, heating peat significantly increases amino acid content when compared to unheated peat. This means that the disclosed heated peat compositions perform as value-added fertilizers.

### Example 5: Transplant Experiments

Arugula establishment and growth using heated peat combinations were compared to unheated peat and industry standards.

Arugula seeds (Eruca sativa) [Johnny's Selected Seeds 2015G.3072257] were planted Dec. 1, 2022 in 5 substrates: Heated Peat (HP), Unheated Sedge Peat (SP), ProMix (PM), HP:PM 50:50 mix and SP:PM 50:50 mix and allowed to emerge under misthouse conditions. Two (2) healthy arugula seedling plants were then transplanted Dec. 28, 2022 into 3-gallon fabric grow bags containing either ProMix (PM), SunGro (SG) or LifeSoils (LS) growing substrates.

Plants were observed over the next 3-month period and harvested twice during the trial. One plant from each grow bag was removed Jan. 25, 2023, roots washed, measured [root length=average of 3 measurements, inches] and dried for biomass (grams) along with top shoot growth for dried biomass. The second plant was allowed to continue until Mar. 21, 2023 and second harvest was completed and trial finalized. All data was subject to statistical analysis and significant means identified (Table 14). Abbreviations in Table 14 are as follows: HP=Heated Reed Sedge Peat; HP:PM=Heated Reed Sedge Peat 50%:ProMix 50%; SG=SunGro Metro Mix Media; SP=Unheated Reed Sedge Peat; SP:PM=Unheated Reed Sedge Peat 50%:ProMix 50%; LS=Life Soils Command Compost Media; PM=ProMix High Porosity Media.

TABLE 14
Arugula Seedling Grow Bag Trial; Plant Deconstruction Harvests

| | | Harvest 1 (Jan. 25, 2023) | | | Harvest 2 (Mar. 21, 2023) | | |
|---|---|---|---|---|---|---|---|
| SEED | GROW | ROOT | ROOT | SHOOT | ROOT | ROOT | SHOOT |
| EMERG. | BAG | LENTH | DRY WT. | DRY WT. | LENTH | DRY WT. | DRY WT. |
| MEDIA | MEDIA | (in) | (g) | (g) | (in) | (g) | (g) |
| HP | PM | 8.1b | 2.1cd | 0.18b | 12.2ab | 1.39cde | 5.7d |
| SP | PM | 4.6ef | 0.34e | 0.02c | 5.5def | 0.24e | 1.1de |
| PM | PM | 6.2cd | 0.77e | 0.05c | 6.8cde | 0.89de | 2.6de |
| HP | SG | 4.2efg | 0.17e | 0.01c | 5.2def | 0.03e | 0.1e |
| SP | SG | 3.6fg | 0.04e | 0.003c | 0.0g | 0.0e | 0.0e |
| PM | SG | 3.0fg | 0.14e | 0.006c | 2.6efg | 0.003e | 0.01e |
| HP | LS | 6.8bcd | 2.63bc | 0.24b | 11.5b | 3.64ab | 33.1b |
| SP | LS | 5.5de | 0.81e | 0.06c | 10.3bc | 2.58bc | 22.1c |
| PM | LS | 6.6bcd | 1.17de | 0.06c | 8.9bcd | 2.25bcd | 22.7c |
| HP:PM | PM | 9.7a | 0.88e | 0.08c | 11.9ab | 2.09cd | 2.9de |
| SP:PM | PM | 6.4cd | 0.86e | 0.05c | 8.3bcd | 0.33e | 1.2de |
| HP:PM | SG | 7.4bc | 0.22e | 0.04c | 2.4efg | 0.01e | 0.03e |
| SP:PM | SG | 2.9g | 0.14e | 0.002c | 1.6fg | 0.009e | 0.02e |
| HP:PM | LS | 10.3a | 5.0a | 0.52a | 15.8a | 4.62a | 38.5a |
| SP:PM | LS | 6.9bcd | 3.4b | 0.28b | 8.5bcd | 2.85bc | 24.4c |
| — | — | *** | *** | *** | *** | *** | *** |

*** = P < 0.001
Means with the same letter within a column are not significantly different.

Thus, transplanting seedlings that were initiated in heated peat, then transplanted to a variety of industry standard media, increased root length, root dry weight, and shoot dry weight for two harvests. There was no fertilizer added to these soils. These results indicate that heated peat improve transplant success of plants in a variety of media.

### Example 6: Conclusion

Based on WDPT, both HSS and HSP were hydrophobic at the substrate surface interface for only 7 days, but maintained severe hydrophobic properties at one to six cm depths for a period of 77 continuous days under the conditions of receiving daily irrigation, no vegetative cover, and maintained inside a greenhouse. Therefore, both HSS and HSP represent valid methods that could be used to produce hydrophobic or water repellent sands and sand mixtures for use in research. Using these two methods to evaluate amelioration techniques for soil water repellency under controlled laboratory or greenhouse conditions, or small-scale field conditions warrant further assessment and validation.

Both methods of hydrophobizing sand—HSP and HSS—were considered effective and reasonably successful in the laboratory and greenhouse. Neither HSS nor HSP was phytotoxic to bermudagrass sprigs. Both hydrophobizing methods may have initially hindered turfgrass establishment and quality mimicking what would be encountered in water repellent field soils. This increase in soil water repellency may have decreased soil moisture availability by preventing infiltration into soils and perhaps creating preferential flow paths which would not have distributed water evenly throughout the pots. Based on WDPT from the greenhouse experiments, both HSS and HSP were slightly to strongly water repellent over time, while WSAND and WSP remained wettable over time.

As the greenhouse experiments progressed, the response of bermudagrass in WSAND versus HSS was different in Experiment One but similar in Experiment Two, and the response of bermudagrass in WSP versus HSP was similar in Experiment One but different in Experiment Two. This turfgrass response may be attributed to increased wettability of what was a previously severely hydrophobic substrate and/or the availability of nutrients due to the heating of the peat component of the substrate. As suggested previously, the heating of peat releases and increases ammonium-N, P, and K in soils. In these greenhouse experiments, perhaps the increased wettability of HSP and the additional nutrients provided an optimum turfgrass root growing environment as evidenced by the significantly improved bermudagrass cover, rooting, and quality in HSP when compared to all other treatments. Heating reed sedge peat significantly increased root establishment and overall shoot counts when the trial was run for 132 days (over 4 months). HSP an thus emulate a slow release, 4-month organic fertilizer.

When using these hydrophobic root zone substrates (i.e., HSS or HSP) to test the effects of water repellency in the laboratory or greenhouse, consideration should be given to specific parameters to evaluate. For example, HSS and HSP could be used to evaluate water repellency effects on plant growth, and to evaluate amelioration strategies by testing experimental soil surfactants, biostimulants, and cultural practices. While the hydrophobicity of HSS and HSP lasted for approximately 77 days under daily irrigation while inside a greenhouse, the hydrophobic duration is unknown if a plant is introduced into the substrate or if maintained under different growing or environmental conditions. It is implied that the “manufactured” water repellency of HSS or HSP lasts for a finite period and is not permanent.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Andriesse, J. P. 1988. Nature and management of tropical peat soils. Food and agriculture organization of the United Nations. Rome. No. 59.
2. Bauters, T. W. J., et al, 1998: Preferential flow in water repellent sands. Soil Sci. Soc. Am. J 62, 1185-1190.
3. Bigelow, C. A., et al. 2001. Creeping bentgrass response to inorganic soil amendments and mechanically induced subsurface drainage and aeration. Crop Sci. 41: 797-805.
4. Bigelow, C. A., et al. 2004(a). Inorganic soil amendments limit nitrogen leaching in newly constructed sand-based putting green rooting mixtures. USGA Turfgrass and Environmental Research Online 2:1-7.
5. Bigelow, C. A., et al. 2004(b). Physical properties of three sand size classes amended with inorganic materials or sphagnum peat moss for putting green rootzones. Crop Sci. 44: 900-907.
6. Boyle, K et al. Jul. 31, 2002. United States Environmental Protection Agency. IIFG Decision Documents on Reassessment of Exemptions form the Requirement of a Tolerance for Fatty Acids. Online Resource. Accessed Mar. 1, 2022.
7. Buczko, U., et al. 2005. Variability of soil water repellency in sandy forest soils with different stand structure under Scots pine (Pinus sylvestris) and beech (Fagus sylvatica). Geoderma 126:317-336.
8. Cann, M. A. 2000. Clay spreading on water repellent sands in the southeast of South Australia-promoting sustainable agriculture. J. Hydrology. 231-232:333-341.
9. Cisar, J. L., et al. 2000. The occurrence and alleviation by surfactants of soil water repellency on sand-based turfgrass systems. J. Hydrol. 231/232: 352-358.
10. Cloyd, R. Oct. 21, 2021. Fundamental of Using Soaps as Insecticides. Kansas State University Extension Entomology. Online Resource. Accessed Mar. 1, 2022.
11. Cooley, E. T., et al. 2009. Surfactant use to improve soil water distribution and reduce nitrate leaching in potatoes. Soil Sci. 174(6):321-329.
12. Curtis, M. J., et al. 2008. An alternative method for measuring plant available water in inorganic amendments. Crop Sci. 48: 2447-2452.
13. Dekker, L. W., et al. 2001. Water repellency and critical soil water content in a dune sand. Soil. Sci. Soc. Am. J. 65: 1667-1674.
14. Dekker, L. W., et al. 2003. More than one thousand references related to soil water repellency. 315-352. In. Soil Water Repellency:Occurrences, Consequences and Amelioration. Elsevier. Amsterdam, The Netherlands.
15. Dekker, L. W. et al. 2003. 167-178. Wetting patterns in water repellent Dutch soils. In: Soil Water Repellency: Occurrence, Consequences and Amelioration. Elsevier, Amsterdam, Netherlands.
16. Dekker, L. W., et al. 2009. Methods for determining soil water repellency on field-moist samples. Water Resources Research 45:W00D33.
17. Dlapa, P., et al. 2004. Effect of kaolinite and Ca-montmorillonite on the alleviation of soil water repellency. Plant Soil Environ. 50(8):358-363.
18. Fidanza, M., et al. 2020. Communication of soil water repellency causes,
19. problems, and solutions of intensively managed amenity turf from 2000 to 2020. Journal of Hydrology and Hydromechanics 68(4):306-312.
20. Fisher Scientific Octadecyltrichlorosilane Material Safety Data Sheet retrieved on Sep. 15, 2015.
21. Fisher Scientific. 2022. Stearic Acid Material Safety Data Sheet. ACC #95204. Revised Jul. 20, 2009. Retrieved Mar. 1, 2022.
22. Gross, A., et al. 2011. Effectiveness of wetting agents for irrigating sandy soils. Journal of Australian Water Association 38:1-4.
23. Hallettt, P. D., et al. 2001. Microbially derived water repellency in golf course soil. Int. Turfgrass Soc. Res. J. 9: 518-524.
24. Hallett, P. D. et al. 2001. Subcritical water repellency of aggregates from a range of soil management practices. Soil Sci. Soc. J. 65:184-190.
25. Ivory. Proctor&Gamble. Online Resource. Accessed Mar. 1, 2022.
26. Johnson, M. S. et al. 2005. Spatial and temporal variability of soil water repellency of Amazonian pastures. Australian Journal of Soil Research, 43(3), 319+.
27. Karnok, K. J. et al. 2001. Wetting agent treated hydrophobic soil and its effect on color, quality and root growth of creeping bentgrass. International Turfgrass Society Research Journal 9:537-541.
28. Keizer, J. J., et al. 2005. Soil water repellency under dry and wet antecedent weather conditions for selected land-cover types in coastal zone of central Portugal. Australian Journal of Soil Research. 43:297-308.
29. Kim, D R., et al. 2021. Glutamic acid reshapes the plant microbiota to protect plants against pathogens. Microbiome 9:244.
30. Leighton-Boyce, G., et al. 2005. Temporal dynamics of water repellency and soil moisture in eucalypt plantations, Portugal. Australian J. of Soil Research. 43:269-280.
31. Ma'shum, M., et al. 1988. Extraction and characterization of water repellent materials from Australian soils. J. Soil Sci 39: 99-110.
32. McMillan, M. 2016. The Influence of Hydrophobicity, Inorgranic Amendments and Surfactants on Turfgrass Establishment, Growth and Quality in Constructed rootzone mixes. University of Florida, PhD dissertation.
33. Mead, R., et al. 2003. Statistical Methods in Agriculture and Experimental Biology. Chapman and Hall/CRC Press, Boca Raton, FL.
34. Moody, D. R., et al. 2009. Soil water repellency development in amended sand rootzones. Crop Sci 49: 1885-1892.
35. Murphy, J. A., et al. 2005. Creeping bentgrass establishment on amended-sand root zones in two microenvironments. Crop Sci 45: 1511-1520.
36. National Center for Biotechnology Information, 2022. PubChem Compound Summary for CID 5281, Stearic acid. Online Resource. Accessed Mar. 1, 2022.
37. Oostindie, K., et al. 2008. Soil surfactant stops water repellency and preferential flow paths. Soil Use and Management. 24:4, 409-415.
38. Orfanus, T. et al. 2008. Spatial variability of water repellency in pine forest soil. Soil and Water Res. (3). (Special Issue 1) S123:129.
39. Osborn, J. 1968. The effect of wetting agents and water repellency on the germination and establishment of grass. Proceedings of the symposium on water-repellent soils. University of California, Riverside. May 6-10. 327-333.
40. Perdana, L. R., et al. 2018. Hydrophilic and hydrophobic characteristics of dry peat. 2^{nd} International Tropical Renewable Energy Conference. IOP Conf. Series: Earth and Environmental Science 105.
41. Potter, R. S. et al. 1918. Effects of heat on nitrogenous constituents of soil. Soil Sci. Vol V. No. 3. 197-212.
42. Robichaud, P. R. 2003. Infiltration rates after prescribed fire in Northern Rocky Mountain forests. 203-211. In. Soil Water Repellency:Occurrences, Consequences and Amelioration. Elsevier. Amsterdam, The Netherlands.
43. Schlossberg, M. J.; et al. 2005. Development of water repellency in sand-based rootzones. Int. Turf. Res. Soc 10: 1123-1130.
44. Song, E. J. G. et al. 2014. Wetting agent influence on water infiltration into hydrophobic sand:1. Rewettability. Agron. J. 106:5 1873-1878.
45. Spormann S, et al. Accumulation of Proline in Plants under Contaminated Soils—Are We on the Same Page? Antioxidants (Basel). 2023; 12:666.
46. Steenhuis, T. S., et al. 2001. Water repellency in New York state soils. International Turfgrass Society Research Journal 9: 624-628.
47. Turgeon, A. J. et al. 2019. Turfgrass management. Turfpath LLC, State College, PA.
48. Waddington, D. V., 1992. Soils, soil mixtures and soil amendments. P. 331-383. In D. V. Waddington et al., (ed.) Turfgrass. Agron. Mongor. 32. ASA, Madison, WI.
49. Waltz, C. et al. 2003. Managing water-repellent soils with inorganic soil amendments. Golf Course Management. August. 71(8): p. 87-90.
50. Waltz, F. C., Jr., et al. 2003. Physical and hydraulic properties of rootzone mixes amended with inorganics for golf putting greens. Agron. J 95: 395-404.
51. Wasura, J. P., et al. 2001. Physical stability of inorganic amendments used in turfgrass rootzones. Int. Turfgrass Soc. Res. J 9: 636-641.
52. Woche, S. K., et al, 2005: Contact angle of soils as affected by depth, texture, and land management. European Journal of Soil Science 56, 239-251.
53. York, C. A. et al. 2000. Water repellent soils as they occur on UK golf greens. J. Hydrology 231-232: 126-133.
54. Zontek, S. J. et al. 2012. Understanding the Different Wetting Agent Chemistries. Green Section Record. 50:15. 1-6. TGIF 208432.

What is claimed is:

1. A method for creating a slow-release fertilizer, the method comprising:
(a) heating a composition comprising peat to a temperature of from about 175° C. to about 200° C.; and
(b) allowing the composition to cool to ambient temperature, thereby creating the fertilizer.

2. The method of claim 1, wherein the composition in step (a) further comprises a filler material, or wherein following step (b), the method further comprises blending the fertilizer with a filler material.

3. The method of claim 2, wherein the filler material comprises sand, perlite, vermiculite, limestone, or any combination thereof.

4. The method of claim 1, wherein the peat comprises reed sedge peat, sphagnum peat, Latvian peat, Florida peat, or any combination thereof.

5. The method of claim 2, wherein the fertilizer comprises from about 75% to about 99.5% (v/v) of filler material and from about 0.5% to about 25% (v/v) of peat.

6. A slow-release fertilizer produced by the method of claim 1.

7. The slow-release fertilizer of claim 6, wherein the slow-release fertilizer is hydrophobic.

8. The slow-release fertilizer of claim 6, wherein the slow-release fertilizer has a water drop penetration time of at least 5 seconds.

9. The slow-release fertilizer of claim 8, wherein the slow-release fertilizer maintains the water drop penetration time for at least about 11 weeks.

10. The slow-release fertilizer of claim 6, wherein the slow-release fertilizer has a pH of about 6.3.

11. The slow-release fertilizer of claim 6, wherein the slow-release fertilizer comprises from about 0.5% to about 75% organic matter.

12. The slow-release fertilizer of claim 6, wherein the slow-release fertilizer has a sodium level of from about 30% to about 40% of a sodium level in an otherwise identical composition that has not been subjected to heat treatment.

13. The slow-release fertilizer of claim 6, wherein the slow-release fertilizer has a calcium level of from about 125% to about 160% of a calcium level in an otherwise identical composition that has not been subjected to heat treatment.

14. The slow-release fertilizer of claim 6, wherein a leachate from the slow-release fertilizer has a nitrate level of from about 150% to about 200% of a nitrate level in a leachate from an otherwise identical composition that has not been subjected to heat treatment.

15. The slow-release fertilizer of claim 6 wherein a leachate from the slow-release fertilizer has an ammonia level of from about 125% to about 160% of an ammonia level in a leachate from an otherwise identical composition that has not been subjected to heat treatment.

16. The slow-release fertilizer of claim 6, wherein the slow-release fertilizer comprises an increased level of at least one amino acid compared to an otherwise identical fertilizer that has not been heat treated.

17. The slow release fertilizer of claim 16, wherein the amino acid comprises cysteine, methionine, lysine, alanine, aspartic acid, glutamic acid, glycine, isoleucine, leucine, proline, threonine, valine, arginine, histidine, phenylalanine, serine, tyrosine, tryptophan, hydroxylysine, hydroxyproline, lanthionine, ornithine, taurine, or any combination thereof.

18. The slow-release fertilizer of claim 6, wherein the slow-release fertilizer has a saturated hydraulic conductivity of about 91.4 cm/h.

19. A method for improving the growth of a plant, the method comprising applying the slow-release fertilizer of claim 6 to soil in which the plant is growing.

20. The method of claim 19, wherein improving the growth of a plant comprises increased percent cover for a ground cover plant, root length, root area, shoot length, shoot area, number of shoots, or any combination thereof, compared to an otherwise identical plant that has not been treated by the method.
